(19) United States
(12) Patent Application Publication
(10) Pub. No.: US 2023/0049266 A1
(43) Pub. Date: Feb. 16, 2023

(54) STEAM VALVE

(71) Applicant: MITSUBISHI HEAVY INDUSTRIES, LTD., Tokyo (JP)

(72) Inventor: Hiroshi Igawa, Yokohama (JP)

(73) Assignee: MITSUBISHI HEAVY INDUSTRIES, LTD., Tokyo (JP)

(21) Appl. No.: 17/886,322

(22) Filed: Aug. 11, 2022

(30) Foreign Application Priority Data
Aug. 16, 2021 (JP) 2021-132414

(51) Int. Cl. F16K 31/52; F16C 29/02

(52) U.S. Cl. CPC F16K 31/52; F16C 29/02

(57) ABSTRACT

Provided is a steam valve including a valve seat, a valve disc capable of contacting the valve seat, a valve rod connected or linked to the valve disc, a bush that slidably supports the valve rod, and an actuator that moves the valve disc via the valve rod, in which the valve rod has thereon a plurality of groves depressed to an inner side in a diametrical direction of the valve rod and a plurality of projections formed between the plurality of grooves, and each of the plurality of projections in an axial cross section of the valve rod is shaped so as to have one tip point.

### BACKGROUND OF THE INVENTION

### 1. Field of the Invention

The present invention relates to a steam valve.

### 2. Description of the Related Art

A steam turbine includes a steam valve for interrupting supply of steam when the steam turbine stops or enters an abnormal state or for adjusting the supply flow rate of steam in response to a load. This steam valve includes a valve seat, a valve disc capable of contacting the valve seat, a valve rod connected or linked to the valve disc, a bush of a cylindrical shape that slidably supports the valve rod, and an actuator that moves the valve disc via the valve rod.

The valve rod in Patent Document 1 has a plurality of grooves depressed to the inner side in a diametrical direction of the valve rod in order to allow steam between the valve rod and the bush to escape to the outside. Therefore, the valve rod has a plurality of projections formed between the plurality of grooves. Each of the projections in an axial cross section of the valve rod is shaped such that it has one tip side parallel to the axial direction of the rod valve.

### PRIOR ART DOCUMENT

### Patent Document

Patent Document 1: JP-S56-031602-U

### SUMMARY OF THE INVENTION

As described above, the valve rod in Patent Document 1 has a plurality of grooves. Therefore, in comparison with an alternative valve rod that does not have a plurality of grooves, the valve rod in Patent Document 1 can reduce the adhesion amount of scale to the outermost side in a diametrical direction of the valve rod. Consequently, it is possible to secure a gap between the valve rod and the bush thereby to allow the valve rod to move smoothly. However, the inventors of the present invention found that, if the shape of the plurality of projections formed between the plurality of grooves is improved, then the adhesion amount of scale to the outermost side in a diametrical direction of the valve rod can be reduced furthermore.

It is a first object of the present invention to provide a steam valve in which the adhesion amount of scale to the outermost side in a diametrical direction of a valve rod can be reduced.

A case is supposed in which the plurality of grooves in Patent Document 1 are formed not on the valve rod but alternatively on the bush. Also in this case, if the shape of the plurality of projections formed between the plurality of grooves is improved, then it is possible to reduce the adhesion amount of scale to the innermost side in a diametrical direction of the bush.

It is a second object of the present invention to provide a steam valve in which the adhesion amount of scale to the innermost side in a diametrical direction of a bush can be reduced.

In order to achieve the first object described above, according to an aspect of the present invention, there is provided a steam valve including a valve seat, a valve disc capable of contacting the valve seat, a valve rod connected or linked to the valve disc, a bush that slidably supports the valve rod, and an actuator that moves the valve disc via the valve rod, in which the valve rod has thereon a plurality of groves depressed to an inner side in a diametrical direction of the valve rod and a plurality of projections formed between the plurality of grooves, and each of the plurality of projections in an axial cross section of the valve rod is shaped so as to have one tip point.

In order to achieve the second object described above, according to another aspect of the present invention, there is provided a steam valve including a valve seat, a valve disc capable of contacting the valve seat, a valve rod connected or linked to the valve disc, a bush that slidably supports the valve rod, and an actuator that moves the valve disc via the valve rod, in which the bush has thereon a plurality of groves depressed to an outer side in a diametrical direction of the bush and a plurality of projections formed between the plurality of grooves, and each of the plurality of projections in an axial cross section of the bush is shaped so as to have one tip point.

With the steam valve according to the first aspect of the present invention, the adhesion amount of scale to the outermost side in a diametrical direction of the valve rod can be reduced. With the steam valve according to the second aspect of the present invention, the adhesion amount of scale to the innermost side in a diametrical direction of the bush can be reduced.

The above and other objects, features and advantages of the present invention will become apparent from the following description and the appended claims, taken in conjunction with the accompanying drawings.

### BRIEF DESCRIPTION OF THE DRAWINGS

FIG. 1 is an axial cross sectional view depicting a structure of a valve rod and a bush of a steam valve according to a first embodiment of the present invention;

FIG. 2 is an axial cross sectional view depicting a structure of a valve rod and a bush of a steam value according to a first modification of the present invention;

FIG. 3 is an axial cross sectional view depicting a structure of a valve rod and a bush of a steam valve according to a second embodiment of the present invention;

FIG. 4 is an axial cross sectional view depicting a structure of a valve rod and a bush of a steam value according to a second modification of the present invention;

FIG. 5 is a perspective view depicting the structure of a steam valve in the first embodiment of the present invention;

FIG. 6 is a cross-sectional view taken along a cross-section VI-VI in FIG. 5;

FIG. 7 is a partial enlarged cross-sectional view taken at a portion VII in FIG. 6; and

FIG. 8 is a cross-sectional view taken along a cross-section VIII-VIII in FIG. 5.

### DESCRIPTION OF THE PREFERRED EMBODIMENTS

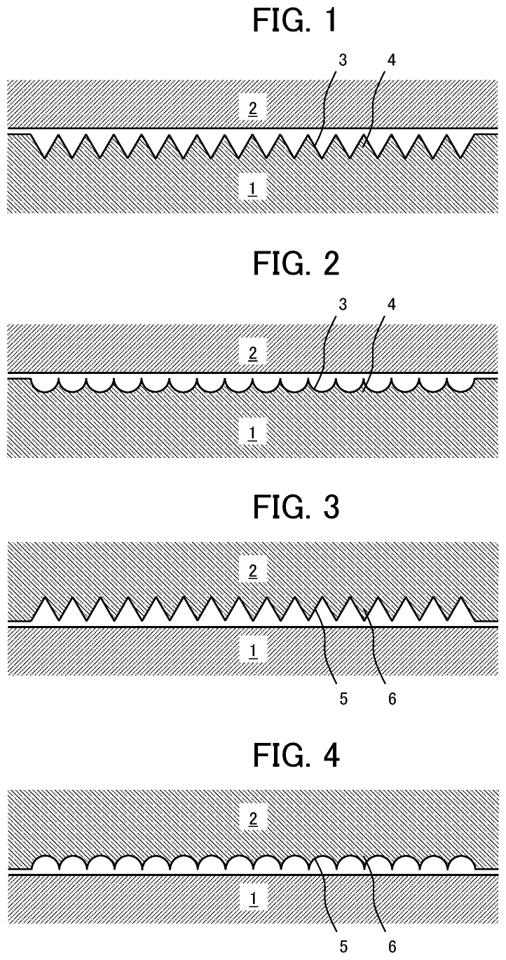

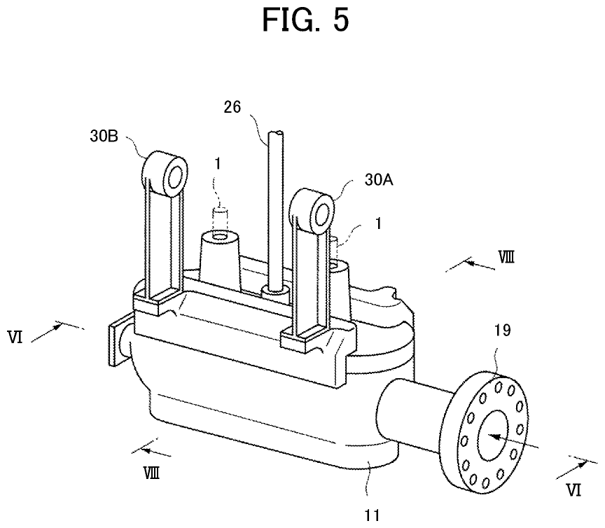

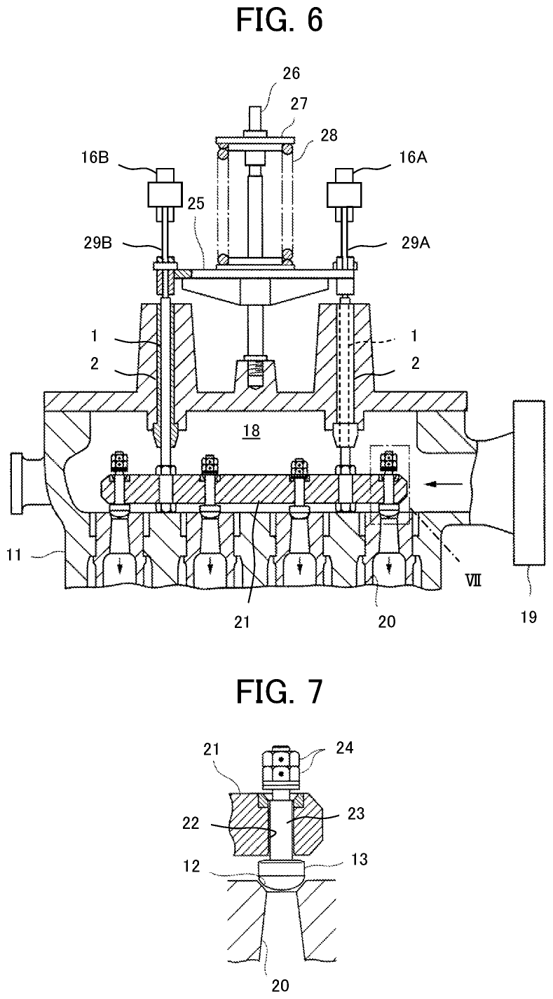

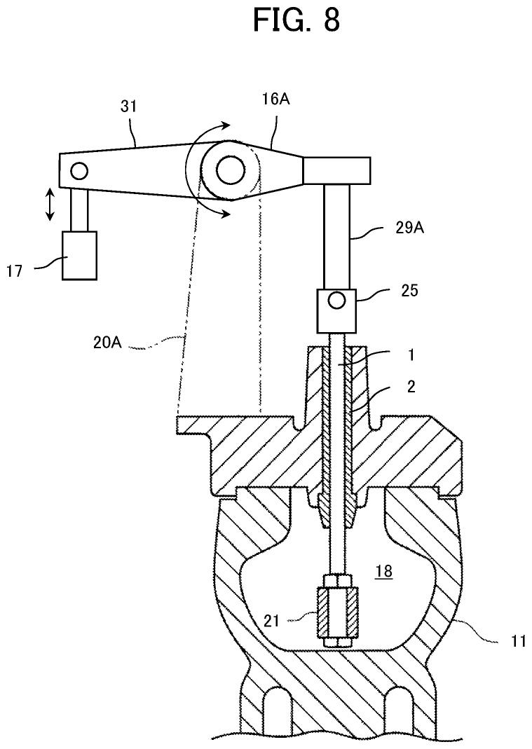

A first embodiment of the present invention is described with reference to the figures. FIG. 1 is an axial cross sectional view of a valve rod and a bush of a steam valve according to the present embodiment. FIG. 5 is a perspective view depicting the structure of a steam valve in the present embodiment, and some sections thereof are omitted in the figure for convenience purposes. FIG. 6 is a cross-sectional view taken along a cross-section VI-VI in FIG. 5, and FIG. 7 is a partial enlarged cross-sectional view taken at a portion VII in FIG. 6. FIG. 8 is a cross-sectional view taken along a cross-section VIII-VIII in FIG. 5. The leftward and rightward direction in FIG. 1 or the upward and downward direction in FIGS. 6 and 8 is an axial direction of the valve rod and the bush.

The steam valve of the present embodiment includes: a plurality of valve seats 12 (four valve seats 12 in the present embodiment) that are formed inside a casing 11; a plurality of valve discs 13 (four valve discs 13 in the present embodiment) each of which is capable of contacting a corresponding one of the plurality of valve seats 12; a pair of valve rods 1 that are linked to the plurality of valve discs 13, extend in a vertical direction, and penetrate the casing 11; a pair of cylindrical bushings 2 that are provided to the casing 11, and respectively support the pair of valve rods 1 slidably (in other words, movably in the axial direction); a pair of levers 16A and 16B that are respectively linked to the upper ends of the pair of valve rods 1; and an actuator 17 (specifically, a hydraulic cylinder or a servomotor) that causes the pair of levers 16A and 16B to pivot.

A steam chest (valve chest) 18 is formed inside the casing 11, and a steam inlet port 19 is formed at a side section of the casing 11 and communicates with the steam chest 18. Thereby, high-temperature and high-pressure steam can be introduced into the steam chest 18 via the steam inlet port 19. A plurality of steam supply ports 20 are formed at a bottom section of the casing 11, and communicate with the steam chest 18. Each of the plurality of valve seats 12 is formed at an opening edge section of a corresponding one of the plurality of steam supply ports 20. The plurality of valve discs 13, which make the degrees of opening of the plurality of valve seats 12 variable, make it possible to adjust the supply rate of steam supplied from the steam chest 18 to a casing (not depicted) of the steam turbine.

A valve lifting plate 21 is arranged in the steam chest 18 of the casing 11. A plurality of through-holes 22 are formed through the valve lifting plate 21, and each of a plurality of rods 23 is inserted to a corresponding one of the plurality of through-holes 22. A valve disc 13 is provided on the bottom side of each rod 23, and double nuts 24 are screwed onto a screw section on the top side of each rod 23. By adjusting the position of the double nuts 24 relative to each rod 23, it is made possible to adjust the lower limit position of descending motion of each valve disc 13 relative to the valve lifting plate 21, and adjust opening and closing timings of each valve seat 12. By making opening and closing timings of the plurality of valve seats 12 different, it is made possible to vary the degree of opening of the plurality of valve seats 12 stepwise as a whole.

The lower ends of the valve rods 1 are coupled to the valve lifting plate 21. The upper ends of the valve rods 1 are coupled to each other via a coupling member 25. Specifically, male screw sections at the upper ends of the valve rods 1 are screwed into female screw sections at both ends of the coupling member 25.

A guide rod 26 is arranged upright on the top side of the casing 11, and is inserted into a through-hole at the middle of the coupling member 25. A spring retaining member 27 is provided at the upper end of the guide rod 26, and a spring 28 is provided between the spring retaining member 27 and the coupling member 25. The spring 28 can urge the plurality of valve discs 13 downward via the coupling member 25, the valve rods 1, and the valve lifting plate 21.

The upper end of the one valve rod 1 is coupled to the lower end of a connecting member 29A via the coupling member 25, and the upper end of the other valve rod 1 is coupled with the lower end of a connecting member 29B via the coupling member 25. Specifically, the lower end of the connecting member 29A and the coupling member 25 are coupled to each other by a pin, and the lower end of the connecting member 29B and the coupling member 25 are coupled to each other by a pin.

One end of the lever 16A is coupled to the upper end of the connecting member 29A, and one end of the lever 16B is coupled to the upper end of the connecting member 29B. The other ends of the levers 16A and 16B are supported by brackets 30A and 30B, respectively, of the casing 11 rotatably. In addition, the other ends of the levers 16A and 16B are linked to the actuator 17 via link members 31. When the actuator 17 causes the levers 16A and 16B to pivot upward or downward, the plurality of valve discs 13 move upward or downward via the connecting members 29A and 29B, the coupling member 25, the valve rods 1, and the valve lifting plate 21. Thereby, the degrees of opening of the plurality of valve seats 12 can vary.

It is to be noted that, although the steam valve of the present embodiment is a steam control valve that adjusts the supply flow rate of steam in response to the load to the steam turbine, a steam valve of the present invention is not restrictive to this. A steam valve of the present invention may be a steam stop valve that interrupts supply of steam when the steam turbine stops or enters an abnormal state. Although the valve rod 1 of the present embodiment is linked to the valve disc 13, a valve rod may be connected to a valve disc.

The valve rod 1 has a plurality of grooves 3 formed on an outer circumferential face of the valve rod 1 and depressed to the inner side in a diametrical direction of the valve rod 1, and a plurality of projections 4 formed between the plurality of grooves 3. The plurality of grooves 3 extend in a circumferential direction of the valve rod 1 in such a manner as to be separate from each other, and the plurality of projections 4 extend in a circumferential direction of the valve rod 1 in such a manner as to be separate from each other. Alternatively, the plurality of grooves 3 may extend spirally in such a manner as to be continuous to each other and the plurality of projections 4 may extend spirally in such a manner as to be continuous to each other.

Each of the projections 4 in an axial cross section of the valve rod 1 has a triangular shape (in other words, a shape having one tip point nearest to the bush 2, two base points, and straight lines interconnecting the tip point and the base points). Due to this shape, in comparison with the projection disclosed in Patent Document 1 and having a shape having one tip side parallel to the axial direction of the valve rod 1, scale is less likely to adhere to the outermost side in a diametrical direction of the valve rod 1. Further, even if scale adheres to the outermost side in a diametrical direction of the valve rod 1, it is easier to peel off. accordingly, the adhesion amount of scale to the outermost side in a diametrical direction of the valve rod 1 can be reduced. As a result, it is possible to secure a gap between the valve rod 1 and the bush 2, thereby to allow the valve rod 1 to move smoothly.

It is to be noted that, although, in the foregoing description of the first embodiment, a triangular shape is taken as an example of the shape of each projection 4 in an axial cross section of the valve rod 1, this is not restrictive, and the shape of each projection 4 may be any shape only if it has one tip point. For example, the shape of each projection 4 may be a shape that has one tip point, two base points, and a curved line interconnecting the tip point and the base points as in a first modification depicted in FIG. 2.

A second embodiment of the present invention is described with reference to FIG. 3. FIG. 3 is an axial cross sectional view depicting a structure of a valve rod and a bush of a steam valve according to the present embodiment. The leftward and rightward direction in FIG. 3 is an axial direction of the valve rod and the bush. It is to be noted that like elements to those in the first embodiment are denoted by like reference characters and description of them is omitted suitably.

In the present embodiment, the bush 2 has a plurality of grooves 5 formed on an inner circumferential face of the bush 2 and depressed to the outer side in a diametrical direction of the bush 2, and a plurality of projections 6 formed between the plurality of grooves 5. The plurality of grooves 5 extend in a circumferential direction of the bush 2 in such a manner as to be separate from each other, and the plurality of projections 6 extend in a circumferential direction of the bush 2 in such a manner as to be separate from each other. Alternatively, the plurality of grooves 5 may extend spirally in such a manner as to be continuous to each other and the plurality of projections 6 may extend spirally in such a manner as to be continuous to each other.

Each of the projections 6 in an axial cross section of the bush 2 has a triangular shape (in other words, a shape having one tip point nearest to the valve rod 1, two base points, and straight lines interconnecting the tip point and the base points). Due to the shape, in comparison with the projection having a shape having one tip side parallel to the axial direction of the bush 2, scale is less likely to adhere to the innermost side in a diametrical direction of the bush 2. Further, even if scale adheres to the innermost side in a diametrical direction of the bush 2, it is easier to peel off. Accordingly, the adhesion amount of scale to the innermost side in a diametrical direction of the bush 2 can be reduced. As a result, it is possible to secure a gap between the valve rod 1 and the bush 2, thereby to allow the valve rod 1 to move smoothly.

It is to be noted that, although, in the foregoing description of the second embodiment, a triangular shape is taken as an example of the cross sectional shape of each projection 6, this is not restrictive, and the shape of each projection 6 may be any shape only if it has one tip point. For example, the shape of each projection 6 may be a shape that has one tip point, two base points, and a curved line interconnecting the tip point and the base points as in a second modification depicted in FIG. 4.

### DESCRIPTION OF REFERENCE CHARACTERS

1: Valve rod
2: Bush
3: Groove of valve rod
4: Projection of valve rod
5: Groove of bush
6: Projection of bush

What is claimed is:

1. A steam valve comprising:
a valve seat;
a valve disc capable of contacting the valve seat;
a valve rod connected or linked to the valve disc;
a bush that slidably supports the valve rod; and
an actuator that moves the valve disc via the valve rod, wherein
the valve rod has thereon a plurality of groves depressed to an inner side in a diametrical direction of the valve rod and a plurality of projections formed between the plurality of grooves, and
each of the plurality of projections in an axial cross section of the valve rod is shaped so as to have one tip point.

2. A steam valve comprising:
a valve seat;
a valve disc capable of contacting the valve seat;
a valve rod connected or linked to the valve disc;
a bush that slidably supports the valve rod; and
an actuator that moves the valve disc via the valve rod, wherein
the bush has thereon a plurality of groves depressed to an outer side in a diametrical direction of the bush and a plurality of projections formed between the plurality of grooves, and
each of the plurality of projections in an axial cross section of the bush is shaped so as to have one tip point.
